(19) United States
(12) Patent Application Publication
(10) Pub. No.: US 2025/0256634 A1
(43) Pub. Date: Aug. 14, 2025

(54) Truck Bed Ramp Arrangement

(71) Applicant: Cooper Williams- Grossklaus, Grosselle, MI (US)

(72) Inventor: Cooper Williams- Grossklaus, Grosselle, MI (US)

(21) Appl. No.: 18/439,905

(22) Filed: Feb. 13, 2024

(51) Int. Cl. B60P 1/43; B62D 33/027

(52) U.S. Cl. CPC B60P 1/435; B60P 1/431; B62D 33/0273

(57) ABSTRACT

A truck bed ramp arrangement includes a truck bed, a tailgate, and a ramp. The truck bed includes a top plate structure and a compartment positioned under it. The tailgate has a recessed portion and a removable insert designed to be placed in the recessed portion. The ramp is stored in the compartment and can be removed out through the compartment and the tailgate for use, then slid back in for storage. The user therefore always has the ramp available to allow the user to easily load and unload objects in and out of the truck bed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to truck bed assemblies and more particularly pertains to a new truck bed ramp arrangement to provide a user with easy access to a ramp arrangement at all times in order to permit a user to load objects into the bed of a truck without substantial effort.

### (2) Description of Related Art Including Information Disclosed Under 37 CFR 1.97 and 1.98

The prior art relates to truck bed assemblies. The prior art, as best understood, does not disclose a ramp arrangement that is stored under the truck bed and can be pulled out from under the truck bed and through the tailgate.

### BRIEF SUMMARY OF THE INVENTION

An embodiment of the disclosure meets the needs presented above in a truck bed ramp arrangement generally comprising a truck bed, a tailgate, and a ramp. The truck bed includes a top plate structure and a compartment positioned under the top plate structure. The tailgate includes a frame having a recessed portion designed to be positioned to face the interior of the truck bed. The tailgate includes a removable insert designed to be placed in the recessed portion and removably attached to the frame to fill the recessed portion and create a continuous interior tailgate surface. The ramp is designed to be stored in the compartment under the top plate structure. The ramp includes two support structures positioned at a first ramp end and designed to project laterally from the sides of the ramp. The ramp includes at least one handle structure positioned at a second ramp end opposite the first ramp end and designed to permit a user to pull the ramp out of an open end of the compartment. The compartment includes two internal guide rail structures positioned on opposite sides of the compartment and designed to support and guide the support structures upon sliding of the ramp into and out of the compartment. The tailgate includes two external guide rail structures positioned on opposite sides of the recessed portion and designed to support and guide the support structures upon sliding of the ramp into and out of the compartment. The two internal guide rail structures and the two external guide rail structures is designed and positioned such that they align with and operatively connect to one another to form a continuous guide path for the two support structures upon the tailgate is pivoted from a vertical closed position to a horizontal open position. The removable insert is removable to expose the recessed portion to permit the ramp to be pulled through and on the tailgate. Each of the two external guide rail structures includes an end stop designed and positioned to stop and retain the support structures upon the ramp is pulled fully out of the compartment and through the recessed portion such that the first ramp end is supported at the end of the tailgate and the second ramp end is supported on the ground to provide an angled ramp for a user to easily enter and exit the truck bed.

The removable insert permits a user to pull the ramp through the tailgate, which otherwise would not be possible as the tailgate would block the ramp from being removed from under the truck bed when the tailgate is lowered into the horizontal or open position. The removable insert also provides a continuous surface with the truck bed so that a user can roll wheeled objects, such as a lawnmower or snowblower, into the truck bed. Since the ramp is stored under the truck bed, it will not interfere with the normal use of the truck bed, but will always be readily available to the user wherever he goes. The removable insert can be removably connected to the frame of the tailgate in any known manner, such as via quick-release pins or slide locks or a form fit or friction fit. The ramp can also be locked into place in its stored position using any number of known locking mechanisms. The ramp itself will be relatively thin, no more than about half the thickness of the tailgate, in order to not take up much space under the truck bed and leave room in the tailgate for reinforcing structures and standard components, such as a tailgate lock and light fixtures. In accordance with at least one possible embodiment, the ramp is about as wide as the wheel wells in the truck bed, such that the ramp is capable of loading any object or item or piece of equipment that would normally fit into the truck bed between the wheel wells. The ramp would therefore be useful for loading smaller items and objects, such as a snowblower, or larger items, such as lawnmowers or vehicles, such as a motorcycle, four-wheeler, or an all-terrain vehicle (ATV).

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a rear view of a truck bed ramp arrangement according to an embodiment of the disclosure.

FIG. 2 is a side view of an embodiment of the disclosure.

FIG. 3 is a top view of an embodiment of the disclosure.

FIG. 4 is a rear view of an embodiment of the disclosure.

FIG. 5 is a rear view of an embodiment of the disclosure.

FIG. 6 is a side view of an embodiment of the disclosure.

FIG. 7 is a top view of an embodiment of the disclosure.

FIG. 8 is a rear view of an embodiment of the disclosure.

FIG. 9 is a side view of an embodiment of the disclosure.

FIG. 10 is a top view of an embodiment of the disclosure.

### DETAILED DESCRIPTION OF THE INVENTION

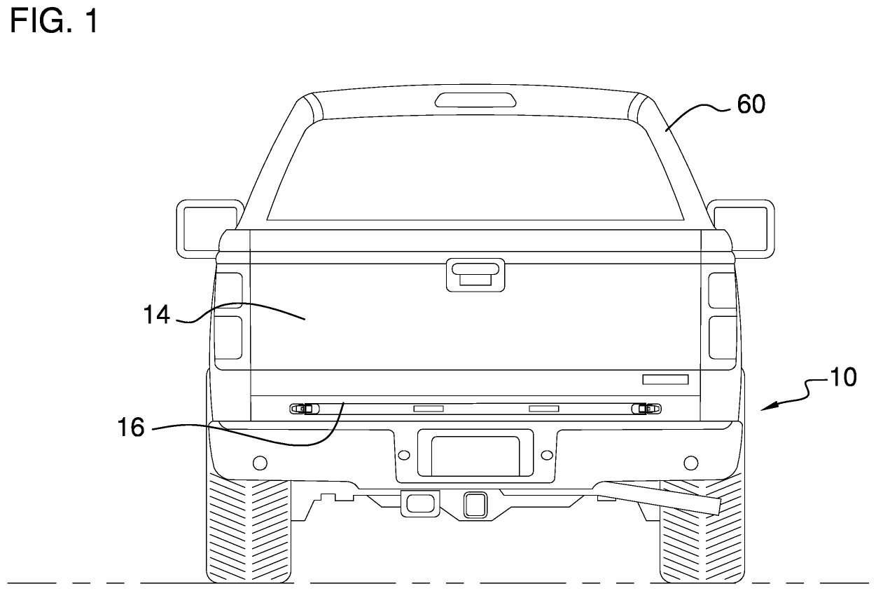

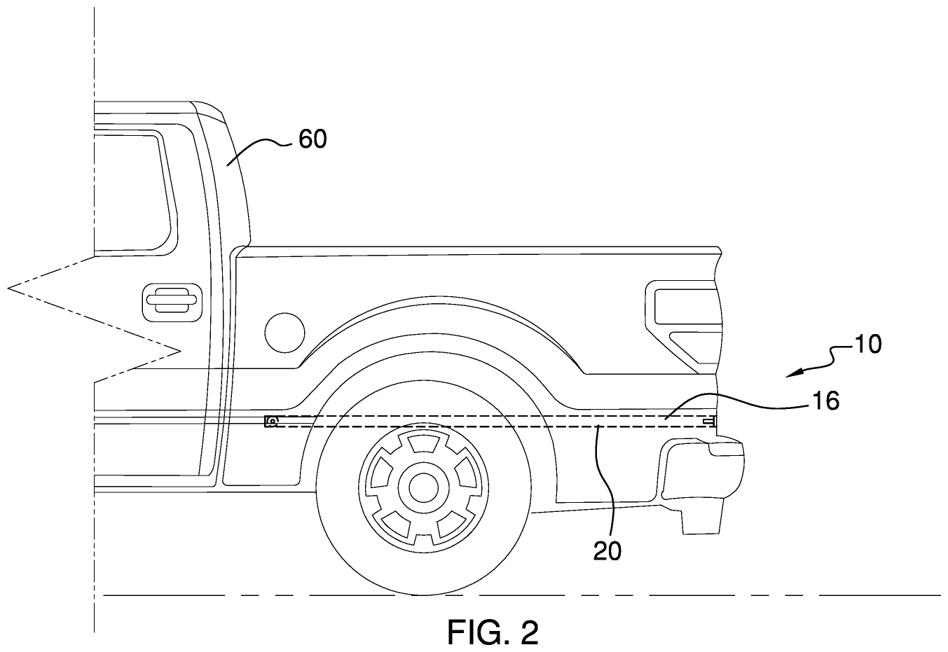

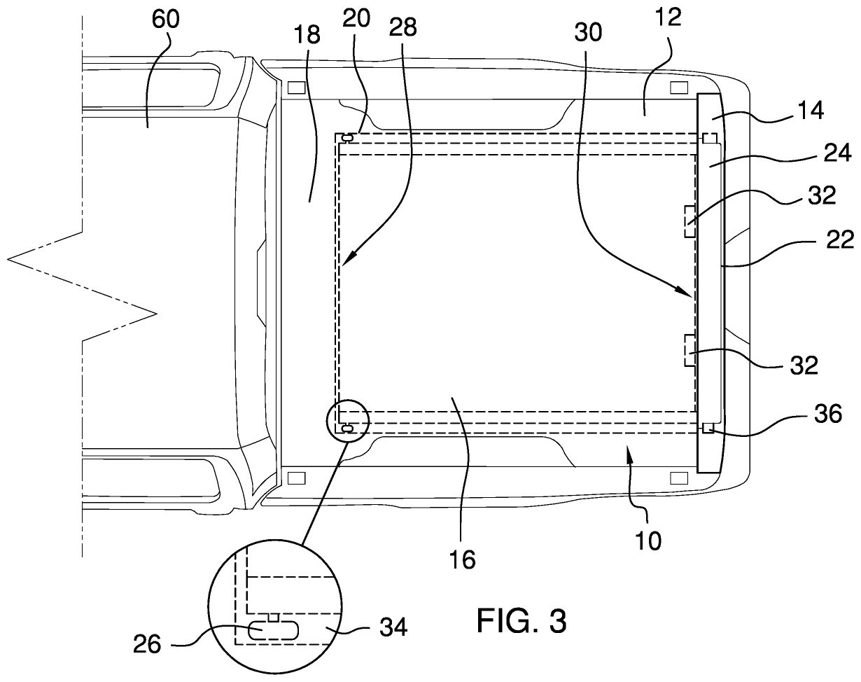

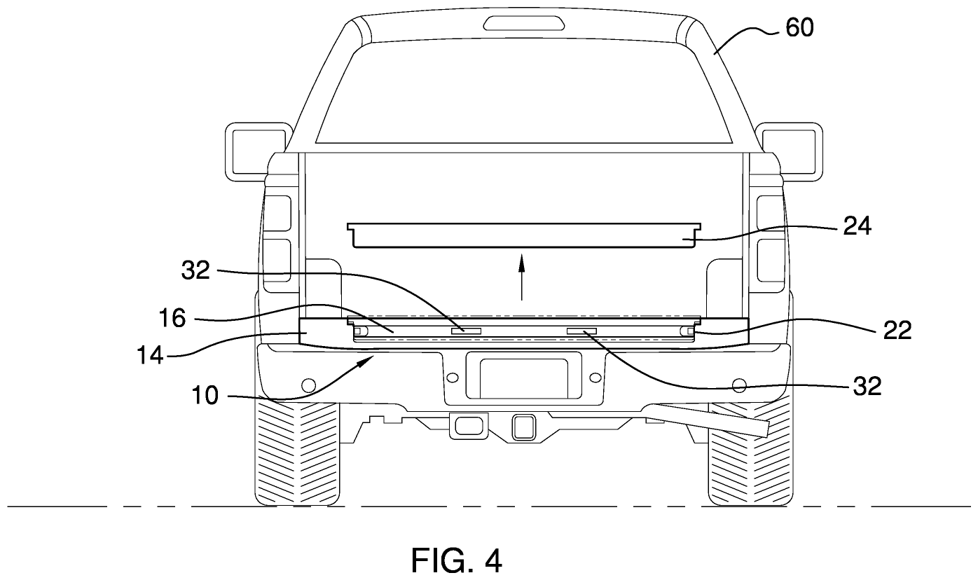

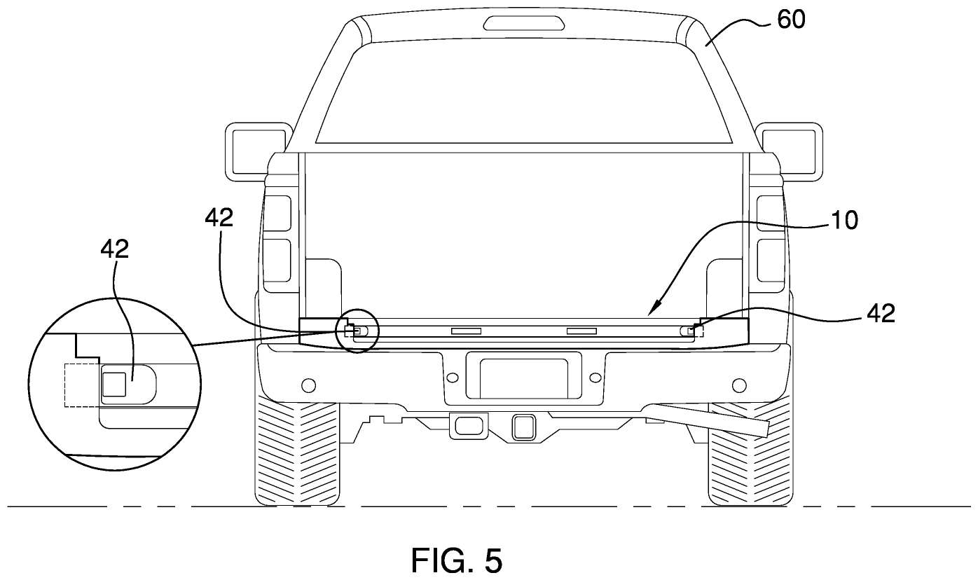

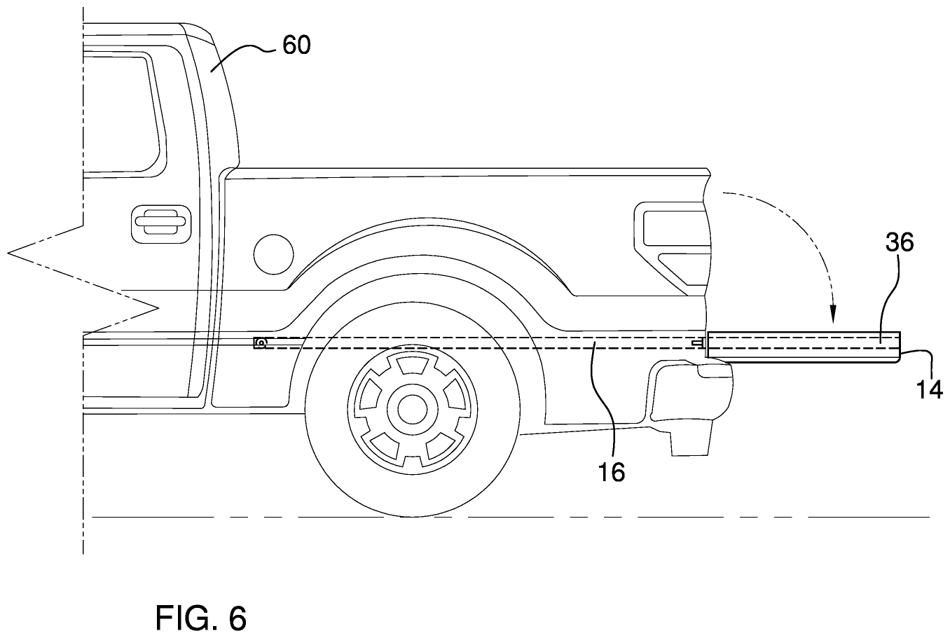

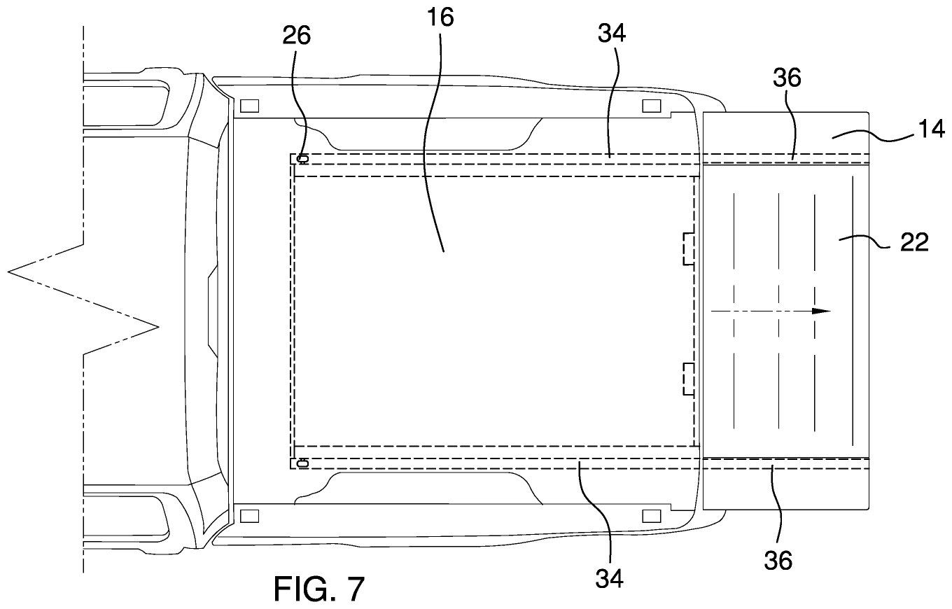

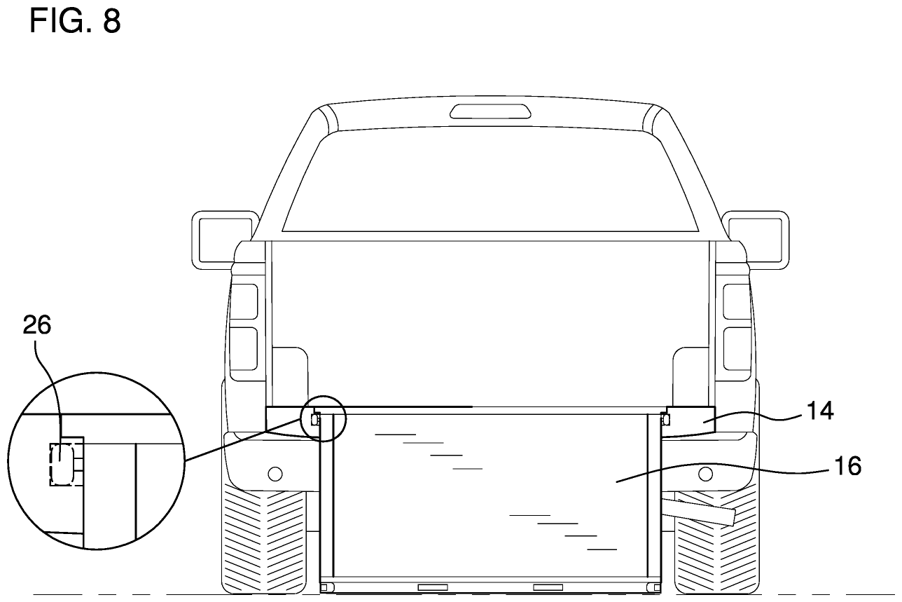

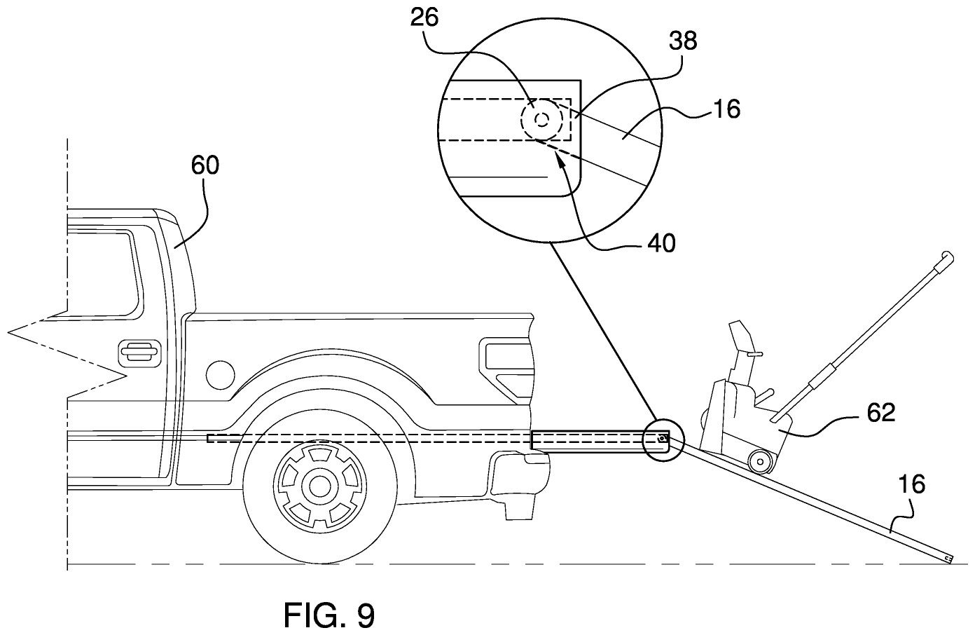

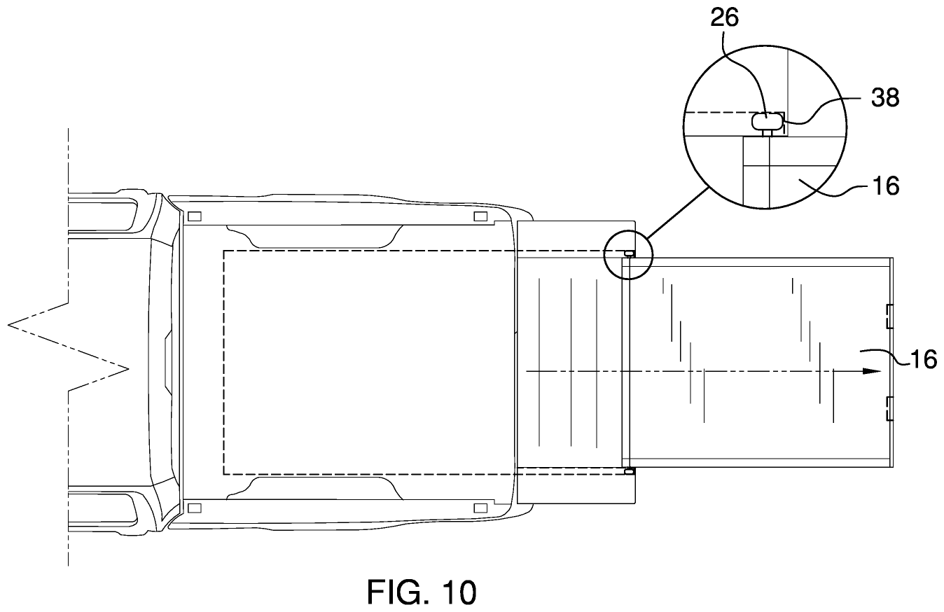

With reference now to the drawings, and in particular to FIGS. 1 through 10 thereof, a new truck bed ramp arrangement embodying the principles and concepts of an embodiment of the disclosure and generally designated by the reference numeral 10 will be described.

As best illustrated in FIGS. 1 through 10, the truck bed ramp arrangement 10 generally comprises a truck bed 12, a tailgate 14, and a ramp 16. The truck bed ramp arrangement 10 is to be installed in a truck 60 with a single-piece tailgate that pivots from a vertical closed position to a horizontal open position. The truck bed 12 includes a top plate structure 18 and a compartment 20 positioned under the top plate structure 18. The tailgate 14 includes a frame having a recessed portion 22 designed to be positioned to face the interior of the truck bed 12. The tailgate 14 includes a removable insert 24 designed to be placed in the recessed portion 22 and removably attached to the frame to fill the recessed portion 22 and create a continuous interior tailgate surface. The ramp 16 is designed to be stored in the compartment 20 under the top plate structure 18. The ramp 16 includes two support structures 26 positioned at a first ramp end 28 and designed to project laterally from the sides of the ramp 16. The ramp 16 includes at least one handle structure 32 positioned at a second ramp end 30 opposite the first ramp end 28 and designed to permit a user to pull the ramp 16 out of an open end of the compartment 20. The compartment 20 includes two internal guide rail structures 34 positioned on opposite sides of the compartment 20 and designed to support and guide the support structures 26 upon sliding of the ramp 16 into and out of the compartment 20. The tailgate 14 includes two external guide rail structures 36 positioned on opposite sides of the recessed portion 22 and designed to support and guide the support structures 26 upon sliding of the ramp 16 into and out of the compartment 20. The two internal guide rail structures 34 and the two external guide rail structures 36 are designed and positioned such that they align with and operatively connect to one another to form a continuous guide path for the two support structures 26 when the tailgate 14 is pivoted from a vertical closed position to a horizontal open position. The removable insert 24 is removable to expose the recessed portion 22 to permit the ramp 16 to be pulled through and on the tailgate 14. Each of the two external guide rail structures 36 includes an end stop 38 designed and positioned to stop and retain the support structures 26 when the ramp 16 is pulled fully out of the compartment 20 and through the recessed portion 22, such that the first ramp end 28 is supported at the end of the tailgate 14 and the second ramp end 30 is supported on the ground to provide an angled ramp 16 for a user to easily enter and exit the truck bed 12.

In accordance with at least one possible embodiment, the recessed portion 22 includes an inclined section 40 positioned at the end of the tailgate 14 and designed to assist in supporting the ramp 16 at a desired angle.

In accordance with at least one possible embodiment, the top plate structure 18 includes metal of sufficient strength and durability to support objects and persons thereon above the compartment 20.

In accordance with at least one possible embodiment, each of the two support structures 26 includes a wheel or roller designed to roll and permit pivoting of the ramp 16 at the end stops 38.

In accordance with at least one possible embodiment, the recessed portion 22 has a depth about half the thickness of the tailgate 14 or less.

In accordance with at least one possible embodiment, the compartment 20 is rectangular and designed to extend across a substantial portion of the top plate structure 18.

In accordance with at least one possible embodiment, the ramp 16 includes locking arrangements 42 positioned at the first ramp end 28 and designed to lock the ramp 16 in its stored position in the compartment 20.

In accordance with at least one possible embodiment, to use the truck bed ramp arrangement 10, the user first pivots the tailgate 14 from a vertical closed position to a horizontal open position. The user removes the removable insert 24 to expose the recessed portion 22, grasps the at least one handle structure 32, and then pulls the ramp 16 out of the open end of the compartment 20. The user continues pulling the ramp 16 into the recessed portion 22 while moving the two support structures 26 along the two internal guide rail structures 34. The user continues pulling the ramp 16 and moves the two support structures 26 along the two internal guide rail structures 34 and into the two external guide rail structures 36. The user continues pulling the ramp 16 until the support structures 26 contact and are stopped by the end stops 38 and the ramp 16 is fully pulled out of the compartment 20. The user then pivots the ramp 16 by lowering the second ramp end 30 until it is supported on the ground. The user then inserts the removable insert 24 back into the recessed portion 22 to form a continuous interior tailgate surface. The user moves at least one object, such as a snowblower 62, onto the ramp 16 and then onto the removable insert 24 of the tailgate 14 and then onto the top plate structure 18 in the truck bed 12. Once the loading job is completed, the user removes the removable insert 24 and exposes the recessed portion 22. The user then lifts the second ramp end 30 and pushes the ramp 16 back into the compartment 20. The user inserts the removable insert 24 back into the recessed portion 22 and then finally pivots the tailgate 14 from the horizontal open position back to the vertical closed position. In accordance with at least one possible embodiment, the user first unlocks the locking arrangements to permit the user to pull the ramp 16 out of the compartment 20, and finally locks the locking arrangements to lock the ramp 16 in its stored position in the compartment 20.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A truck bed ramp arrangement comprising:
a truck bed comprising a top plate structure and a compartment disposed under said top plate structure;
a tailgate comprising a frame having a recessed portion configured to be disposed to face the interior of said truck bed;
said tailgate comprising a removable insert configured to be placed in said recessed portion and removably attached to said frame to fill said recessed portion and create a continuous interior tailgate surface;
a ramp being configured to be stored in said compartment under said top plate structure;
said ramp comprising two support structures disposed at a first ramp end and configured to project laterally from the sides of said ramp;
said ramp comprising at least one handle structure disposed at a second ramp end opposite said first ramp end and configured to permit a user to pull said ramp out of an open end of said compartment;
said compartment comprising two internal guide rail structures disposed on opposite sides of said compartment and configured to support and guide said support structures upon sliding of said ramp into and out of said compartment;
said tailgate comprising two external guide rail structures disposed on opposite sides of said recessed portion and configured to support and guide said support structures upon sliding of said ramp into and out of said compartment;
said two internal guide rail structures and said two external guide rail structures being configured and disposed such that they align with and operatively connect to one another to form a continuous guide path for said two support structures upon said tailgate being pivoted from a vertical closed position to a horizontal open position;
said removable insert being removable to expose said recessed portion to permit said ramp to be pulled through and on said tailgate; and
each of said two external guide rail structures comprising an end stop configured and disposed to stop and retain said support structures upon said ramp being pulled fully out of said compartment and through said recessed portion such that said first ramp end is supported at the end of said tailgate and said second ramp end is supported on the ground to provide an angled ramp for a user to easily enter and exit said truck bed.

2. The truck bed ramp arrangement of claim 1, wherein said recessed portion comprises an inclined section disposed at the end of said tailgate and configured to assist in supporting said ramp at a desired angle.

3. The truck bed ramp arrangement of claim 2, wherein said top plate structure comprises metal of sufficient strength and durability to support objects and persons thereon above said compartment.

4. The truck bed ramp arrangement of claim 3, wherein each of said two support structures comprises a wheel or roller configured to roll and permit pivoting of said ramp at said end stops.

5. The truck bed ramp arrangement of claim 4, wherein said recessed portion has a depth about half the thickness of said tailgate or less.

6. The truck bed ramp arrangement of claim 5, wherein said compartment is rectangular and configured to extend across a substantial portion of said top plate structure.

7. The truck bed ramp arrangement of claim 6, wherein said ramp comprises locking arrangements disposed at said first ramp end and configured to lock said ramp in its stored position in said compartment.

8. The truck bed ramp arrangement of claim 1, wherein said top plate structure comprises metal of sufficient strength and durability to support objects and persons thereon above said compartment.

9. The truck bed ramp arrangement of claim 1, wherein each of said two support structures comprises a wheel or roller configured to roll and permit pivoting of said ramp at said end stops.

10. The truck bed ramp arrangement of claim 1, wherein said recessed portion has a depth about half the thickness of said tailgate or less.

11. The truck bed ramp arrangement of claim 1, wherein said compartment is rectangular and configured to extend across a substantial portion of said top plate structure.

12. The truck bed ramp arrangement of claim 1, wherein said ramp comprises locking arrangements disposed at said first ramp end and configured to lock said ramp in its stored position in said compartment.

13. A method of using the truck bed ramp arrangement of claim 1 comprising the steps of:
pivoting said tailgate from a vertical closed position to a horizontal open position;
removing said removable insert and exposing said recessed portion;
grasping said at least one handle structure and pulling said ramp out of the open end of said compartment;
continuing pulling said ramp into said recessed portion while moving said two support structures along said two internal guide rail structures;
continuing pulling said ramp and moving said two support structures along said two internal guide rail structures and into said two external guide rail structures;
continuing pulling said ramp until said support structures contact and are stopped by said end stops and said ramp is fully pulled out of said compartment;
pivoting said ramp by lowering said second ramp end until it is supported on the ground;
inserting said removable insert back into said recessed portion to form a continuous interior tailgate surface;
moving at least one object onto said ramp and then onto said removable insert of said tailgate and then onto said top plate structure in said truck bed;
removing said removable insert and exposing said recessed portion;
lifting said second ramp end and pushing said ramp back into said compartment;
inserting said removable insert back into said recessed portion; and
pivoting said tailgate from the horizontal open position to the vertical closed position.

14. The method of claim 13, wherein said ramp comprises locking arrangements disposed at said first ramp end, and said method further comprises unlocking said locking arrangements to permit a user to pull said ramp out of said compartment, and locking said locking arrangements to lock said ramp in its stored position in said compartment.
